(19) United States
(12) Patent Application Publication
(10) Pub. No.: US 2026/0003665 A1
(43) Pub. Date: Jan. 1, 2026

(54) RECONCILIATION METHOD FOR TRANSACTION STATE MACHINE IN DISTRIBUTED ENVIRONMENT

(71) Applicant: JPMorgan Chase Bank, N.A., New York, NY (US)

(72) Inventor: Manish Sharma, Delaware, OH (US)

(73) Assignee: JPMorgan Chase Bank, N.A., New York, NY (US)

(21) Appl. No.: 18/756,351

(22) Filed: Jun. 27, 2024

(51) Int. Cl. G06F 9/46; G06F 11/14

(52) U.S. Cl. CPC G06F 9/466; G06F 11/1438

(57) ABSTRACT

Aspects of the subject disclosure may include, for example, obtaining a first state associated with a first microservice that performs a first step in a distributed process comprising a plurality of steps, wherein the first step is one of the plurality of steps; obtaining a second state associated with a second microservice that performs a second step in the distributed process, wherein the second microservice is distinct from the first microservice, and wherein the second step follows the first step; reconciling the first state with first known action data to determine whether a first action indicated by the first state is verified as completed, resulting in a first determination; and reconciling the second state with second known action data to determine whether a second action indicated by the second state is verified as completed, resulting in a second determination. Other embodiments are disclosed.

### FIELD OF THE DISCLOSURE

The subject disclosure relates to a reconciliation method for transaction state machine in distributed environment.

### BACKGROUND

Keeping all the systems in synchronization may be a challenge for certain conventional distributed architectures having multiple child workflows within a super workflow, and costs may rise when such systems do go out of synchronization.

Further, transactions performed in various merchant, banking, and other environments need to be reconciled. Typically, such reconciliation for a given transaction has been performed on the transaction in aggregate after assumed completion of all of the steps of the transaction. In this regard, conventional end-of-day reconciliations are sometimes too late to save the losses that had already occurred during the workflow.

### SUMMARY OF THE DISCLOSURE

One or more aspects of the subject disclosure include a method comprising: obtaining, by a processing system including a processor, a first state associated with a first microservice that performs a first step in a distributed process comprising a plurality of steps, wherein the first step is one of the plurality of steps; obtaining, by the processing system, a second state associated with a second microservice that performs a second step in the distributed process comprising the plurality of steps, wherein the second microservice is distinct from the first microservice, and wherein the second step is one of the plurality of steps that follows the first step; reconciling, by the processing system, the first state with first known action data to determine whether a first action indicated by the first state is verified as completed, resulting in a first determination; and reconciling, by the processing system, the second state with second known action data to determine whether a second action indicated by the second state is verified as completed, resulting in a second determination.

One or more aspects of the subject disclosure include a non-transitory machine-readable medium comprising executable instructions that, when executed by a processing system including a processor, facilitate performance of operations, the operations comprising: obtaining, from a first microservice that performs a first step in a distributed transaction process, a first state associated with the first step; obtaining, from a second microservice that performs a second step in the distributed transaction process, a second state associated with the second step; determining, for each of the first state and the second state whether a corresponding action has actually been performed; in a first case that an action corresponding to the first state has not actually been performed: facilitating a first change of the first state back to a first prior state that had existed before the first state; and facilitating a second change of the second state back to a second prior state that had existed before the second state; and in a second case that an action corresponding to the first state has actually been performed and an action corresponding to the second state has not actually been performed: facilitating a change of the second state back to a second prior state that had existed before the second state.

One or more aspects of the subject disclosure include a device comprising: a processing system including a processor; and a memory that stores executable instructions that, when executed by the processing system, facilitate performance of operations, the operations comprising: obtaining a plurality of states related to a sequence of steps in a transaction, wherein each of the plurality of states is set by a respective microservice running on a respective source system and each of the plurality of states corresponds to a respective step of the sequence of steps; inputting each of the plurality of states into a state machine rule engine; receiving from the state machine rule engine an indication of a problematic state that has an associated action that has not been completed; and sending to the source system associated with the problematic state an indication that the associated action has not been completed.

### BRIEF DESCRIPTION OF THE DRAWINGS

Reference will now be made to the accompanying drawings, which are not necessarily drawn to scale, and wherein:

FIG. 1A is a block diagram illustrating an example, non-limiting embodiment of a system functioning in accordance with various aspects described herein.

FIG. 1B is a block diagram illustrating an example, non-limiting embodiment of a process flow functioning in accordance with various aspects described herein.

FIG. 1C is a block diagram illustrating an example, non-limiting embodiment of a system functioning in accordance with various aspects described herein.

FIG. 1D is a block diagram illustrating an example, non-limiting embodiment of a process flow functioning in accordance with various aspects described herein.

FIG. 1E is a block diagram illustrating an example, non-limiting embodiment of a data flow functioning in accordance with various aspects described herein.

FIG. 1F is a block diagram illustrating an example, non-limiting embodiment of a system functioning in accordance with various aspects described herein.

FIG. 1G is a block diagram illustrating an example, non-limiting embodiment of a process flow functioning in accordance with various aspects described herein.

FIG. 2A depicts an illustrative embodiment of a method in accordance with various aspects described herein.

FIG. 2B depicts an illustrative embodiment of a method in accordance with various aspects described herein.

FIG. 2C depicts an illustrative embodiment of a method in accordance with various aspects described herein.

FIG. 3 is a block diagram of an example, non-limiting embodiment of a computing environment in accordance with various aspects described herein.

### DETAILED DESCRIPTION

The subject disclosure generally relates to a reconciliation method for a transaction state machine in a distributed environment.

Some systems (such as, for example, banking systems) are architected around autonomous event-driven microservices. The autonomous nature of this architecture, however, may lead to an out of sync state between a source system and any critical microservices that make up a transactional workflow. Various embodiments resolve such issues by utilizing a reconciliation manger (which may be a microservice itself) that may be connected to a source (which may also be a microservice) and one or more downstream microservices that are considered critical in the transactional workflow. When a state mismatch/violation occurs between the source and any of these downstream microservices (and/or between any of the downstream microservices themselves) the reconciliation manager may, for example, roll-back the transaction or restart the transaction (e.g., depending upon how a rule engine state machine is configured in accordance with business rules of each microservice being managed by the reconciliation manager).

In various examples, a state mismatch/violation may represent an SLA (service level agreement) or SLO (service level objective) breach, a timeout state (e.g., at source, at one or more intermediate microservices, and/or at target system), and/or a mismatch of timestamps between microservices (e.g., when a timestamp is generated by a source microservice for a particular transaction such transaction's traversal through downstream microservices is monitored for consistency with its assigned timestamp). If there is a mismatch between the timestamp at the source and the timestamp seen at a particular downstream microservice, the mismatch may be the result of the transaction being lost, excessively delayed at any particular downstream microservice, the source terminating the transaction, or other anomalous behavior. Thus, timestamps may effectively serve as transaction IDs monitored by the reconciliation manager.

It will be appreciated that microservices are an architectural and organizational approach to software development where software is composed of small independent services that communicate over well-defined interfaces. Microservices allow a large application to be separated into smaller independent parts, with each part having its own realm of responsibility.

Various embodiments operate in the context of computing architectures (e.g., banking architectures) that are founded on autonomous applications comprised largely of event-driven microservices. These architecture types may support a web-scale model where high availability of services and sustained speed of delivery are vital. In contrast to a more centralized state management architecture (where immediate consistency of state is typically executed), a microservices architecture employs robust transaction management across distributed services using eventual consistency strategies that leverage Brewer's CAP (Consistency, Availability, and Partition tolerance) theorem.

Various embodiments provide a reconciliation service, as a capability, to ensure transaction consistency across the systems. The reconciliation service may be an informed observer of events across microservices that determines when steps of the end-to-end business process are out of expected sequence (and/or have breached service-level agreements) and validate the state of transactions across the systems. Further, the reconciliation service may make immediate reconciliation within the state machine of workflow and may reconcile multiple times with same workflow for each transaction.

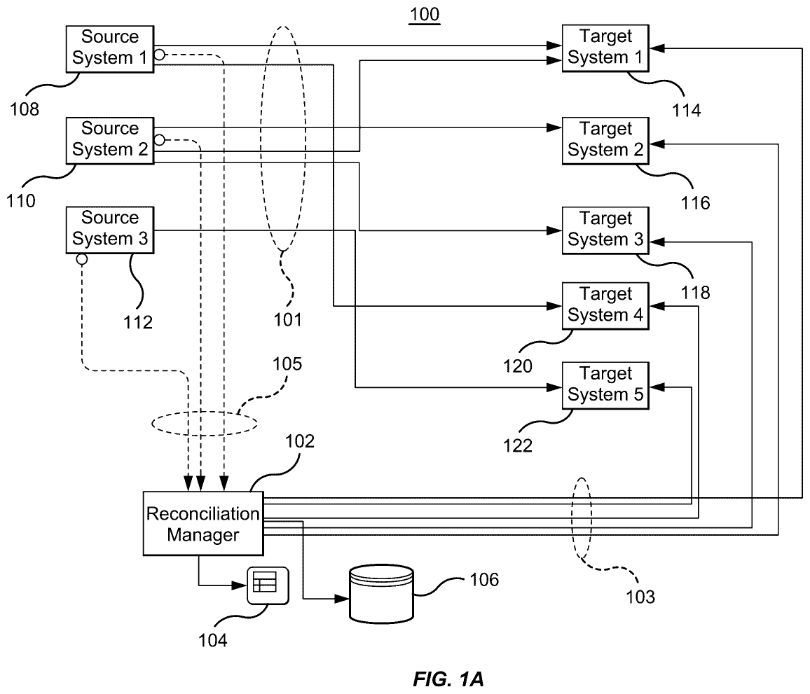

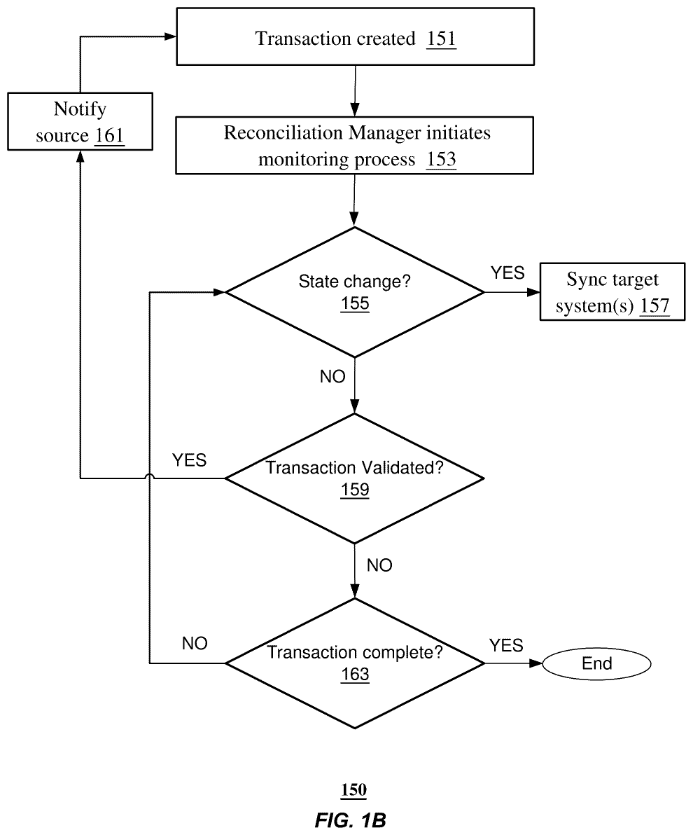

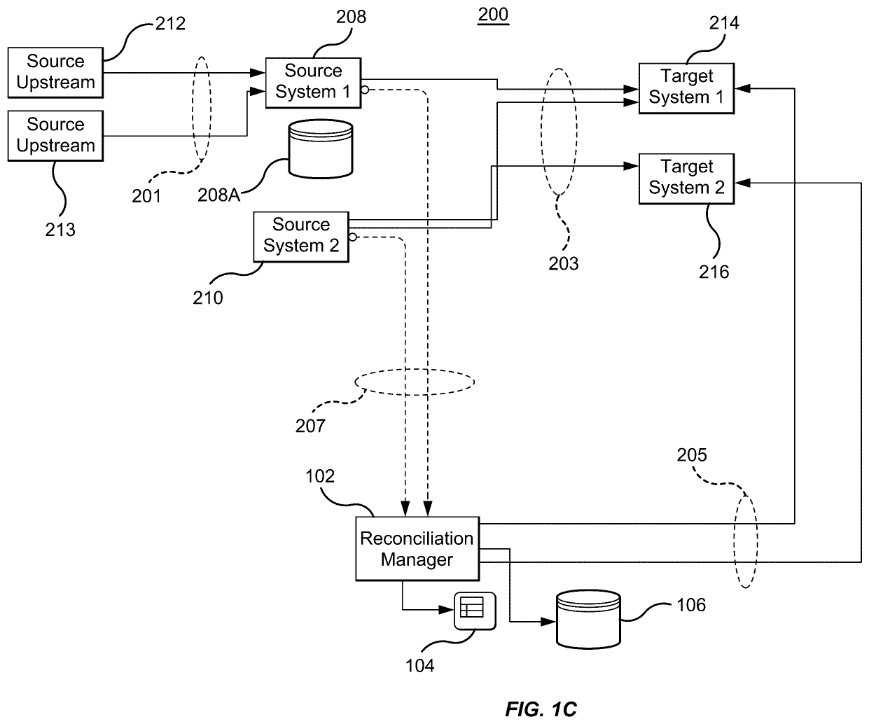

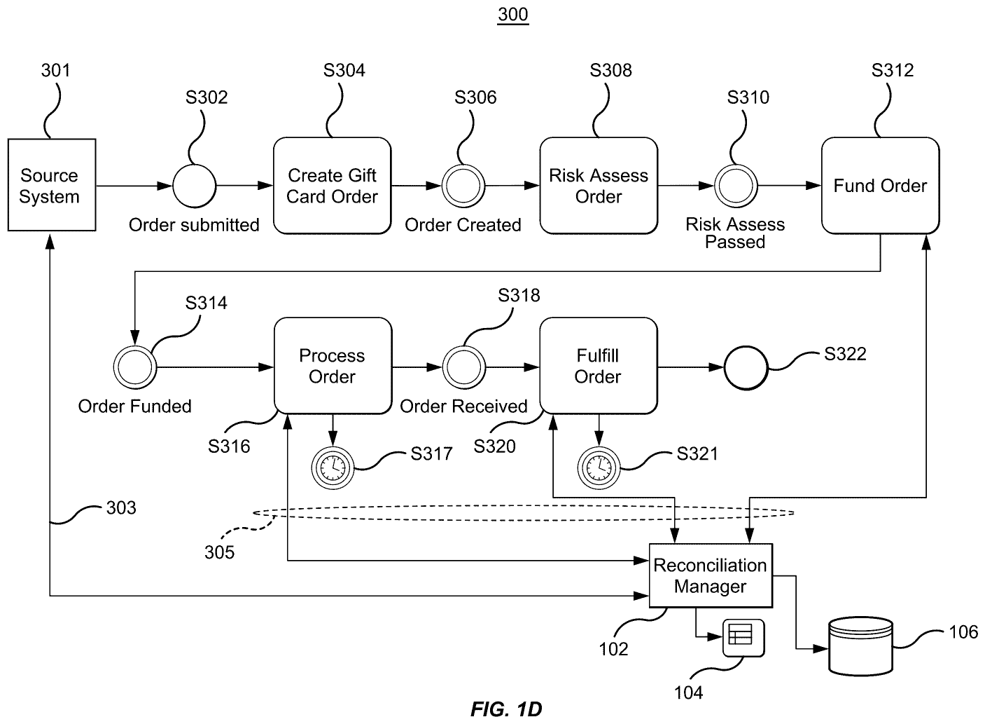

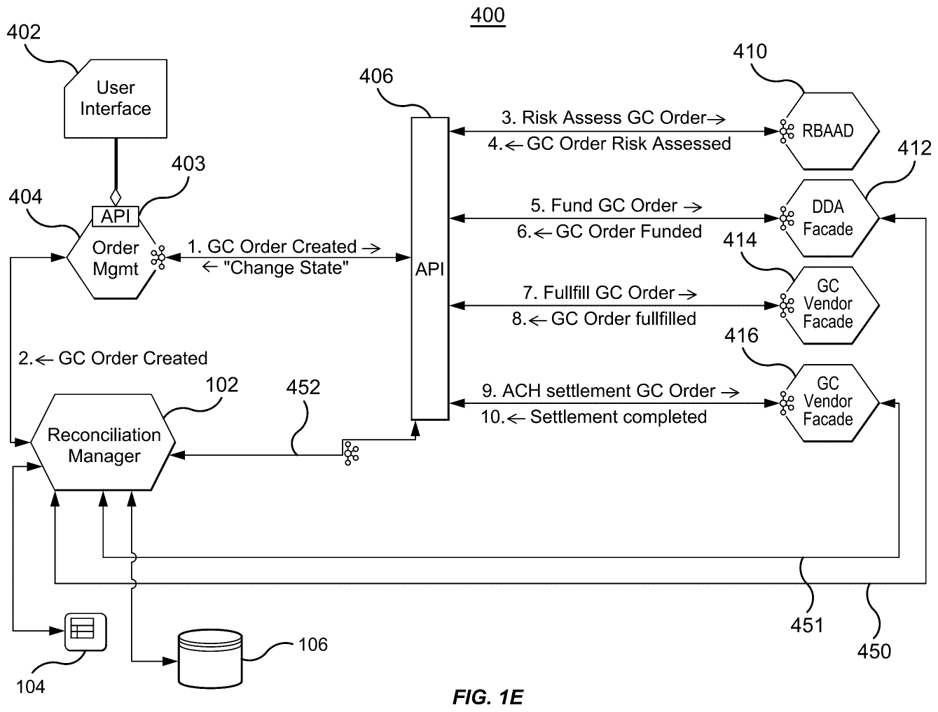

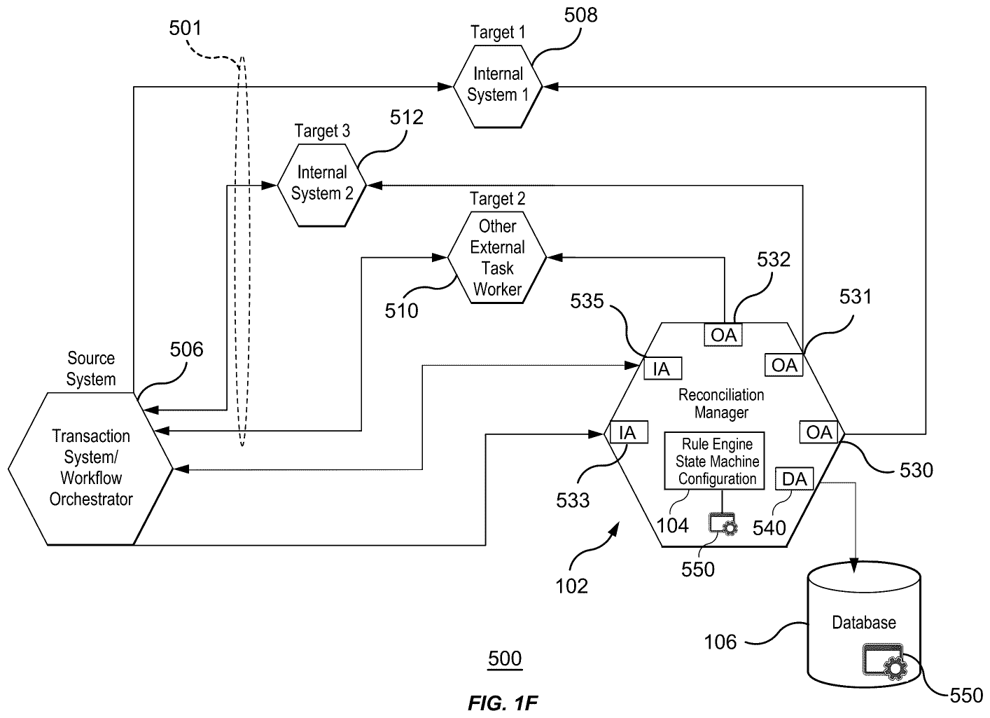

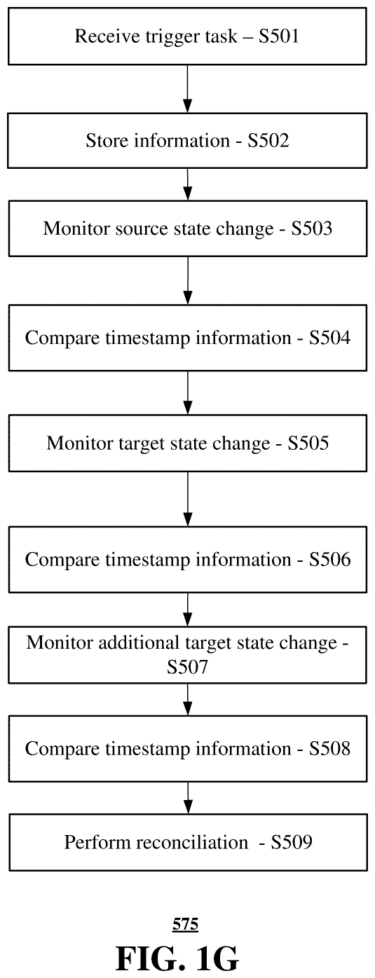

Referring to FIG. 1A, a system 100 is illustrated. The system 100 may include reconciliation manager 102, rule engine state machine 104 (which may include rule engine configurations), database 106, source systems 108, 110, 112 (each may represent individual microservices), and target systems 114, 116, 118, 120, 122 (each may represent individual microservices). The reconciliation manager 102, rule engine state machine 104, and database 106 may collectively represent a microservice. The database 106 may serve to store business rules associated with each microservice in system 100, which the rule engine state machine 104 may access to determine an expected behavior of each microservice, and reconciliation tasks that may be used to mitigate and/or correct an anomaly detected by the reconciliation manager 102. Of course, while three source systems are shown in this example, any desired number of source systems may be supported. Further, while five target systems are shown in this example, any desired number of target systems may be supported. In various embodiments, each of the reconciliation manager 102 and the rule engine state machine 104 may comprise hardware, firmware, software, or any combination thereof.

Still referring to FIG. 1A, the reconciliation manager 102 may receive business events from each of source systems 108, 110, 112 (see, e.g., the arrows collectively identified by interface 105). An event manager (e.g., related to business events) may be embedded within reconciliation manager 102 and/or may be a processing resource of the reconciliation manager 102. Each of source systems 108, 110, 112 may also provide data to the target systems 114, 116, 118, 120, 122 (see, e.g., the arrows collectively identified by interface 101). Based upon the received business events, the reconciliation manager 102 may (e.g., using rule engine state machine 104 and/or data stored in database 106) perform reconciliation tasks as described herein. Further, the reconciliation manager 102 may (e.g., as part of such reconciliation tasks) provide commands, instructions, and/or the like to target systems 114, 116, 118, 120, 122 (see, e.g., the arrows collectively identified by interface 103). In various examples, each of the source systems 108, 110, 112 may be operated by a bank, a merchant, or the like. In various examples, each of the target systems 114, 116, 118, 120, 122 may be operated by a bank, a merchant, or the like.

To enable the detection of anomalies within the execution of a business process, application framework or workflow of the reconciliation manager 102 may maintain the rule engine state machine 104 and invoke the initial reconciliation service for each transaction.

The reconciliation manager 102 may be configured to perform reconciliation service where each reconciliation service may have SLA/SLO (service level agreement/service level objective) information (including requirements) and access to one or more source systems and/or target systems (this may be via, for example, a transaction identifier or identification information (ID) represented by, for example, a timestamp and last status and source update timestamp). Each reconciliation service of the reconciliation manager 102 may also have the configuration and/or rules to reconcile a specific state of a transaction.

The reconciliation service of the reconciliation manager 102 may further include the SLA/SLO for the completion of the business process (e.g., the receipt of the last event in the sequence).

In addition, the reconciliation manager 102 may be configured (such as through the reconciliation service) to also validate the source system update timestamp with target transaction update timestamp to reconcile a transaction.

FIG. 1B illustrates a process flow 150 that may be implemented by system 100 of FIG. 1A. Suppose at step 151 that source system 108 creates a sequence of transactions directed at target system 114, each transaction having a unique timestamp. Further suppose, at step 151 source system 108 creates a second sequence of transactions directed at target system 120, each transaction also having a unique timestamp. Once a timestamp is assigned to a transaction by source system 108, the timestamp remains unchanged within the transaction independent of how many target systems process the transaction. This property enables the reconciliation manager 102 to treat each timestamp as a unique transaction ID that enables the reconciliation manager 102 to monitor the processing of the transaction at target system 114 as well as monitor compliance with expected requirements under an SLA and corresponding SLO applied to target system 114. The foregoing embodiments also apply to the sequence of transactions (with unique timestamps) directed at target system 120.

It will be appreciated that SLA's may provide operators of the source systems shown in FIG. 1A with an overall agreement as to the resources assigned to the source systems (e.g., target systems 114 and 120 assigned to source system 108). The SLO adds further specificity to the SLA. For example, an SLO applied to target system 114 may include a number of metrics monitored by the reconciliation manager 102 such as, for example, an expected processing requirement for target system 114 (e.g., processing must not exceed X milliseconds), uptime of target system 114 (e.g., guaranteed to be in operation XX.XXX %), capacity of transactions that can be processed per minute by target system 114, etc. SLA/SLO combinations, such as those described above, may be applied uniquely to each source system 108, 110, 112 shown in FIG. 1A depending on the operators needs and objectives.

For illustration purposes, the descriptions that follow in relation to flow 150 of FIG. 1B are directed only to source system 108 and corresponding target systems 114 and 120. It will be appreciated, however, that the embodiments described below may be applied to combinations of source system 110 and corresponding target systems 114, 116, 118, as well as source system 112 and corresponding target system 122.

Referring back to FIG. 1B, when source system 108 created (at step 151) the transaction sequences directed at target systems 114 and 120, respectively, the reconciliation manager 102 was notified of these transactions by way of interface 105. Once notified, the reconciliation manager 102 at step 153 begins to monitor state changes by source system 108 in relation to the transactions created at step 151 while such transactions are processed by target systems 114 and 120, respectively. In the present context, a state change may represent, for example, a modification initiated by source system 108 to a previously created transaction at step 151. Non-limiting examples of state changes include termination or roll-back of a transaction, updating the transaction's details (e.g., change in scheduled payment date), restart of the transaction, and so on. Such state changes are monitored by the reconciliation manager 102 at step 155 by way of interface 105.

If a state change is not detected at step 155, the reconciliation manager 102 proceeds to step 159 where it validates transactions at each target system. In certain embodiments, a transaction validation may correspond to at least two steps: (1) confirming that the timestamp associated with the transaction received by the target system is the same as was provided at step 151, and (2) confirming the SLO requirement(s) are satisfied by the target system for the particular transaction.

As noted earlier, each transaction created at step 151 is given a unique timestamp. This timestamp remains with the transaction at all times while being processed by downstream target systems. In preparation for this validation process, the reconciliation manager 102 may be configured to track an expected start time for processing at each target system for a specific transaction. The expected start time may be determined, for example, according to a creation time of the transaction (i.e., the timestamp), expected congestion delays due to transaction volumes, average processing times at each target system the transaction is expected to traverse, and so on. By tracking the expected start times of each transaction, the reconciliation manager 102 may identify a lost transaction or a transaction received by a targeting system with an unrecognizable timestamp (e.g., corrupted in transit or during processing at one of the target systems).

With this in mind, suppose the reconciliation manager 102 detects at step 159 via interface 103 a transaction at target system 114 with an unrecognized timestamp that is about to be processed by target system 114. To prevent an unrecognized transaction from further processing, the reconciliation manager 102 may be configured to instruct target system 114 to disregard the unrecognized transaction. Suppose instead the reconciliation manager 102 determines that a transaction it is tracking having a known unique timestamp has not been received by target system 114 at the expected start time (timeout scenario). Under these circumstances, the reconciliation manager 102 may instruct target system 114 to disregard the transaction with the known timestamp in the event it is received at a later time. It will be appreciated that in the scenario in which the transaction is unrecognized by the reconciliation manager 102, and subsequently disregarded by target system 114 in response to instructions by the reconciliation manager 102, such scenario also causes a timeout for a specific transaction and known timestamp. In one embodiment, the timeout transaction is the same as the unrecognized (corrupted) transaction received by target system 114.

In both scenarios above, the reconciliation manager 102 proceeds to step 161 where it contacts source system 108 which generated the affected transaction notifying it that a particular transaction (with its unique timestamp) has been adversely affected and should be recreated if source system 108 so desires to continue processing the transaction. If source system 108 chooses to continue processing the transaction, it recreates the transaction with a new unique timestamp at step 151 directed to target system 114. At step 153, the reconciliation manager 102 will detect the reinitiated transaction with the new unique timestamp and apply the monitoring process as described above. It will be appreciated that the above descriptions associated with validations based on timestamp (e.g., being treated as a transaction ID) by the reconciliation manager 102 also apply to transactions directed at target system 120.

Referring back to step 159, if the timestamp of the transaction is recognized and has been received at or before the expected start time for processing at target system 114, the reconciliation manager 102 proceeds to determine if SLO requirements at target system 114 are satisfied. For example, upon detecting that a transaction with a recognized timestamp is ready for processing by target system 114, the reconciliation manager 102 may track the processing time of the transaction by target system 114 and compare measured results with the SLO requirement. If the SLO time limit for processing the transaction is not exceeded, the reconciliation manager 102 may consider the transaction validated and proceed to step 163. At step 163, the reconciliation manager 102 may determine if other downstream target systems need to perform further processing on the transaction. In the illustration of target system 114 of FIG. 1A, there are no further downstream target systems. Accordingly, the reconciliation manager 102 may conclude the monitoring process for the transaction in question has been completed. However, had there been more downstream target systems after target system 114, the above validations based on a timestamp and a SLO would have been applied by the reconciliation manager 102 to these other downstream target systems as described above. Once again it will be appreciated that the above descriptions associated with validations based on a timestamp and a SLO by the reconciliation manager 102 also apply to transactions directed at target system 120.

Referring back to step 159, if instead the reconciliation manager 102 detects the SLO time limit is exceeded, the reconciliation manager 102 may inform target system 114 to temporarily suspend the transaction and proceeds to step 161 where it contacts source system 108 notifying it that the affected transaction was not processed in accordance with the SLO processing time requirement. Source system 108 may decide whether to restart the transaction, or allow it to proceed to the next target system (if there is one) and record the SLO violation for future reference. If source system 108 chooses the former, source system 108 may notify the reconciliation manager 102 that it has chosen to restart the transaction. The reconciliation manager 102 in turn may inform target system 114 to disregard the transaction. If source system 108 chooses the latter, source system 108 may notify the reconciliation manager 102 that it has chosen to allow the transaction to proceed. The reconciliation manager 102 in turn may inform target system 114 to complete processing of the transaction and convey it to another downstream target system (if there is one). Once more, it will be appreciated that the above descriptions associated with SLO infractions detected by the reconciliation manager 102 also apply to transactions directed at target system 120.

The above descriptions are associated with the reconciliation manager 102 not detecting at step 155 a stage change for a particular transaction. Suppose, however, a state change is detected at step 155 for a particular transaction monitored by the reconciliation manager 102. When this happens, the reconciliation manager 102 proceeds to step 157 where it synchronizes any affected downstream target systems expected to receive the transaction in question that has experienced a stage change. In certain embodiments where source system 108 indicates to the reconciliation manager 102 that the state change (e.g., delivery date of payment to recipient, etc.) does not require a restart of the transaction, synchronization may correspond to informing the one or more affected downstream target systems of the state change. Once synchronized, the affected downstream target systems apply this state change while the transaction is being processed. It will be appreciated that the reconciliation manager 102 may also be configured with business rules to determine independently when a state change does or does not require a restart of the transaction.

Now suppose source system 108 determines the state change requires a rollback and restart of the transaction. In this scenario, synchronization may correspond to the reconciliation manager 102 instructing the one or more affected target systems to disregard the affected transaction. In this embodiment, source system 108 generates a new transaction and corresponding new unique timestamp at step 151 that replaces the prior transaction. Once the new transaction has been generated, the reconciliation manager 102 initiates the monitoring process at step 153 as described above.

It will be appreciated that since there are no further downstream target systems after target systems 114 and 120, synchronization would only take place at target system 114 or target system 120 depending on the path of the affected transaction. Had there been other downstream target systems, the reconciliation manager 102 would configure these other target systems as needed according to synchronization step 157 described above. It will be further appreciated that process flow 150 may be adapted to monitor a subset of the target systems in any particular embodiment of a transactional architecture.

While for purposes of simplicity of explanation, the respective processes are shown and described as a series of blocks in FIG. 1B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein. As will be described below, process flow 150 of FIG. 1B may be adapted for application to the embodiments of FIGS. 1C, 1D, 1E, 1F and 1G.

Referring now to FIG. 1C, a system 200 is illustrated. The system 200 may include reconciliation manager 102, rule engine state machine 104, database 106, source systems 208, 210, and target systems 214, 216. Of course, while two source systems are shown in this example, any desired number of source systems may be supported. Further, while two target systems are shown in this example, any desired number of target systems may be supported. In various embodiments, each of the reconciliation manager 102 and the rule engine state machine 104 may comprise hardware, firmware, software, or any combination thereof.

Still referring to FIG. 1C, the reconciliation manager 102 is in communication with each of source systems 208, 210 and may receive various information such as information representative of business events (see, e.g., the arrows collectively identified by 207). Each of the source systems 208, 210 may be in communication with the target systems 214, 216 and may provide various data, such as associated with the business events (see, e.g., the arrows collectively identified by 203). Source system 208 may also communicate with database 208A. Further, source system 208 may receive data from source upstream 212 and source upstream 213 (see, e.g., the arrows collectively identified by 201). Source upstream 212 and source upstream 213 may each represent source microservices that themselves may initiate transactions that converge on a single source system 208. Based upon the received business events, the reconciliation manager 102 may (e.g., using rule engine state machine 104 and/or data stored in database 106) perform reconciliation tasks as described herein. Further, the reconciliation manager 102 may (as part of such reconciliation tasks) provide commands, instructions, and/or the like to target systems 214, 216 (see, e.g., the arrows collectively identified by 205). In various examples, each of the source systems 208, 210 may be operated by a bank, a merchant, or the like. In various examples, each of the target systems 214, 216 may be operated by a bank, a merchant, or the like.

It will be appreciated that although system 200 of FIG. 1C corresponds to a different configuration from system 100 of FIG. 1A, the process flow 150 of FIG. 1B may be adapted and applied to the configurations shown in FIG. 1C. Application of process flow 150 enables the reconciliation manager 102 to detect new transactions created by source systems 208 and 210 and in response initiate a monitoring process for such transactions that includes among other things state change monitoring of these transactions at source systems 208 and 210, synchronizing target systems 214 and 216 when state changes are detected for these transactions, performing validations based on a timestamp and a SLO at target systems 214 and 216, and remedying mismatches.

Referring now to FIG. 1D, a process flow 300 is illustrated which involves a source system 301, the reconciliation manager 102, and the database 106. Process flow 300 is illustrated with respect to an example business process (e.g., a gift card order), but may be applied to other types of multi-step transactions or processes. The process flow 300 may be initiated by the source system 301. The source system 301 may be in communication with the reconciliation manager 102 (see, e.g., the arrow indicated by 303), which may be in communication with (or executing) the rule engine state machine 104 and the database 106.

The process flow 300 may include various steps or actions such as: tasks that are illustrated in FIG. 1D as rounded rectangles (e.g., create gift card order S304); events which are illustrated in FIG. 1D as circles (e.g., order created S306); and activities associated with SLAs/SLOs (including requirements of the SLAs/SLOs) which are illustrated in FIG. 1D as timers S317, S321. Each task depicted in FIG. 1D may represent a separate microservice or its aggregate, and each event may represent the state change of that aggregate. An aggregate may correspond to at least one entity such as an aggregate root, also called root entity or primary entity. An aggregate may also have multiple child entities and value objects, with all entities and objects working together to implement a specific behavior and transactions.

Still referring to FIG. 1D, the process flow 300 may proceed at step S302 where the source system 301 submits an order (e.g., associated with a gift card), which results in initiating a task at step S304 for creating a gift card order. At step S306, the gift card order may be created, which then results in initiation of a task for a risk assessment of the gift card order at step S308. At step S310, if the risk assessment is passed, the process flow 300 proceeds to initiating a task at step S312 for funding of the gift card order. At step S314, the gift card order is funded resulting in processing of the gift card order at step S316, which is further subject to the requirements of the SLA/SLO at step S317 for processing of a gift card order. At step S318, the gift card order is then received which initiates the task of fulfilling the order at step S320 which is subject to the requirements of the SLA/SLO at step S321 for fulfilling of a gift card order. At step S322, the process flow 300 for this particular gift card order is completed.

Still referring to FIG. 1D, the reconciliation manager 102 may monitor, track, and/or roll-back any required step and/or microservice (see, e.g., the arrows collectively indicated by 305). More particularly, in one embodiment, a given timestamp may serve as an ID from a source such as from source system 301 (or other microservice) that is tracked through each downstream microservice. In the illustration of FIG. 1D, the reconciliation manager 102 may be configured to service critical downstream microservices such as the task S312 (fund order), task S316 (process order) and task S320 (fulfill order). A timestamp mismatch between the source system 301 and any of tasks S312, S316 and S320 could represent a transaction that was lost or experiencing excessive delay in the workflow. In one or more embodiments, a timestamp mismatch may also (or alternatively) trigger an SLA/SLO violation.

It will be appreciated that data flow 300 of FIG. 1D may be combined in whole or in part or otherwise adapted to process flow 150 of FIG. 1B. For example, assuming steps S312, S316, and S320 are performed by one or more microservices, process flow 150 can be applied to FIG. 1D enabling the reconciliation manager 102 to detect new transactions created by source system 301 and in response initiate a monitoring process for such transactions that includes among other things state change monitoring of these transactions at the one or more microservices, synchronizing the one or more microservices when state changes are detected for these transactions, performing validations based on a timestamp and a SLO at the one or more microservices, and remedying mismatches.

Referring now to FIG. 1E, an embodiment of a data flow 400 is presented that reflects a reconciliation process that may be used by any of the systems of the subject disclosure, including but not limited to, the workflow reconciliation manager 102 of FIGS. 1A, 1C, 1D. The data flow 400 illustrates an example related to eGift Card reconciliation (which has been simplified for illustration purposes). In operation, the example eGift Card reconciliation depicted in the data flow 400 may proceed with the user interface 402 being used by a user (not shown) to input, such as via an API interface 403, an order into an order management element 404. For example, the API interface 403 may be an API that conforms to, or otherwise is based on, REpresentational State Transfer (REST) API architecture to provide flexibility in integrating applications and to connect components in microservices architectures. The order management element 404 may inform (e.g., asynchronously and/or synchronously) reconciliation manager 102 (see arrow “2”) using service API calls 406 (see arrow “1”).

API 406 (e.g., KAFKA®) may send a message to Risk Based Authentication and Authorization decision system (i.e., RBAAD 410) to perform a risk assessment analysis (see arrow “3”) and RBAAD 410 may return a message that the risk has been assessed for the order (see arrow “4”).

API 406 may send a message to DDA (Demand Deposit Account) facade 412 (e.g., a direct deposit logical and/or hardware component) to fund the order (see arrow “5”). DDA facade 412 may then return a message that the order has been funded (see arrow “6”).

Next, API 406 may send a message to gift card vendor facade 414 to fulfill the order (see arrow “7”) resulting in the gift card vendor facade 414 returning a message that the order has been fulfilled (see arrow “8”).

API 406 may then send a message to gift card vendor facade 416 to perform an ACH settlement (see arrow “9”). Then gift card vendor facade 416 may return a message that the settlement is completed (see arrow “10”).

Still referring to FIG. 1E, the reconciliation manager 102 may track or monitor the source (e.g., order management element 404) and target systems (e.g., RBAAD 410, DDA facade 412, GC vendor facades 414, 416), as well as any connections or interfaces therebetween (e.g., API 406) to reconcile a transaction that presents an anomalous behavior such as a mismatched timestamp, SLA/SLO violation, or other anomalous behavior that would risk fulfilment of the transaction between the source and the target systems. For example, the reconciliation manager 102 may perform reconciliation between: (a) the order management element 404 and the funding system (the DDA facade 412) at arrow 450; and (b) the order management element 404 and the settlement system (the gift card vendor facade 416) at arrow 451. Reconciliation may be configured at any transaction state and the reconciliation manager 102 may send instruction(s) to source or target or both to reconcile the transaction (if needed). For example, information may be exchanged at 452 between API 406 and the reconciliation manager 102 to facilitate the reconciliation process. Further, while the reconciliation manager 102 is operational, the individual steps of the eGift card ordering process may run autonomously (such that adding a step before the risk assessment and funding, for example, would only require tracking the last updated timestamp and the state of the eGift card ordering process between the source and target systems). Each of the order management element 404 and the reconciliation manager 102 may comprise hardware, firmware, software, or any combination thereof.

It will be appreciated that data flow 400 of FIG. 1E may be combined in whole or in part or otherwise adapted to process flow 150 of FIG. 1B. For example, process flow 150 can be applied to FIG. 1E enabling the reconciliation manager 102 to detect new transactions created by order management 404 and in response initiate a monitoring process for such transactions that includes among other things state change monitoring of these transactions at target systems 412 and 416, synchronizing at target systems 412 and 416 when state changes are detected for these transactions, performing validations based on a timestamp and a SLO at target systems 412 and 416, and remedying mismatches.

Referring now to FIG. 1F, a system 500 is illustrated. This system 500 may include an architecture that includes reconciliation manager 102. Various business logic may be at the core of a hexagonal architecture. Such a hexagonal architecture may be based upon three principles and techniques: (a) explicitly separate application, domain, and infrastructure; (b) dependencies are going from application and infrastructure to the domain; and (c) boundaries are isolated by using ports and adapters.

Still referring to FIG. 1F, the reconciliation manager 102 may comprise business logic 550 (which may include encoded business processes and which may be contained within, for example, the rule engine state machine configuration 104 and/or the database 106), and adapters (that interface with external applications and other services). These adapters may include outbound adapters (OAs) 530, 531, 532 from reconciliation manager 102 and inbound adapters (IAs) 533 and 535 to reconciliation manager 102. This makes components exchangeable at any level and facilitates test automation. Further, the reconciliation manager 102 may comprise a microservice configured with an autonomous application. The outbound adapters 530, 531, 532 and the inbound adapters 533, 535 may operate as interfaces of the reconciliation manager 102. As an example, the inbound adapters 533, 535 may consume, analyze or otherwise monitor domain events or service calls that other microservices publish to communicate out an aggregate state change. A database adapter (DA) 540 may access the database 106 to save or record the rule engine data and temporary transactions or information representative thereof. It should be understood that the adapters described herein (e.g., the outbound adapters 530, 531, 532, the inbound adapters 533, 535, the database adapter 540, and any other adapter that is used for monitoring, collecting and/or analyzing data, events, communications, or other information) may be implemented by the various embodiments utilizing various hardware and/or software, in various configurations such as a distributed or centralized fashion, including virtual functions, components of reconciliation manager 102, ports of various devices and systems described herein, stand-alone devices, combinations thereof, and so forth.

A rule engine state machine configuration 104 (which, in this example, is part of the reconciliation manager 102) may contain state machine rules and SLA/SLO information with downstream system connection details. In one or more embodiments, the rule engine state machine configuration 104 may include a rule engine for generating rules. Outbound adapters 530, 531, 532 may notify a source system 506 and target systems 508, 510 and 512 as to what the reconciliation manager 102 has observed (including any anomalies). The source system 506 may comprise a transaction system and/or workflow orchestrator. In various embodiments, the construction of the reconciliation service may also include a datastore (e.g., CASSANDRA® key space) for storing transactions that are to be reconciled (e.g., basic transaction information with state and update timestamps).

FIG. 1G illustrates a process flow 575 for reconciliation of a transaction and is described herein with respect to the devices of FIG. 1F. At step S501, a trigger task may be received from an external task connection. For instance, the trigger task may be a function or activity that is part of a process (e.g., a financial transaction) which is intended to be subject to reconciliation. As an example, the reconciliation manager 102 (which may include the rule engine state machine configuration 104) may receive, such as via the inbound adapter 533, the trigger task from the source system 506. At step S502, information may be provided for storage or recordation. For example, the database 106 may receive, via the database adapter 540, information (including rule-based data or information) from the reconciliation manager 102. This information may be saved in the database 106. At step S503, monitoring may be performed for a state change associated with the source system. For example, the reconciliation manager 102 may monitor for state change of source system 506 (e.g., via inbound adapter 535). At step S504, a comparison may be performed with respect to timestamp information. For example, the reconciliation manager 102 may monitor state information and a last update timestamp associated with the target 508. A comparison may then be made with the source update timestamp (e.g., via outbound adapter 530). The target 508 may be, for example, an internal system.

At step S505, monitoring may be performed for a state change associated with the target 510. For example, the reconciliation manager 102 may monitor the state and the last update timestamp associated with the target 510 and at step S506 may perform a comparison with the source update timestamp (e.g., via outbound adapter 532). The target 510 may be, for example, an external system.

At step S507, monitoring may be performed for a state change associated with the target 512. For example, the reconciliation manager 102 may monitor the state and the last update timestamp associated with target 512 and at S508 may perform a comparison with the source update timestamp (e.g., via outbound adapter 531). The target 512 may be, for example, an internal system. At step S509, any detected mismatches may be reconciled, such as by requesting a roll-back of the transaction (e.g., to a previous step in the transaction) or a restart of the transaction (e.g., depending upon how a rule engine state machine is configured in accordance with business rules of each microservice being managed by the reconciliation manager). The source system 506 may communicate various data with each of the targets 508, 510, 512 (see the arrows collectively identified by 501). Process 575 has been described with respect to reconciliation where there are three targets 508, 510, 512, but it should be understood that the process may be applied to other numbers of targets, and more or less monitoring state change and comparing timestamp information steps may be performed during the process.

It will be appreciated that process flow 575 of FIG. 1G may be combined in whole or in part or otherwise adapted to process flow 150 of FIG. 1B. For example, process flow 150 can be applied to FIG. 1G enabling the reconciliation manager 102 to detect new transactions created by source system 506 and in response initiate a monitoring process for such transactions that includes among other things state change monitoring of these transactions at target systems 508, 510 and 512, synchronizing at target systems 508, 510 and 512 when state changes are detected for these transactions, performing validations based on a timestamp and a SLO at target systems 508, 510 and 512, and remedying mismatches.

As described herein, microservices patterns may be used to design and deploy reconciliation service microservices. A reconciliation service (according to various embodiments such as performed by or utilizing reconciliation manager 102 described above) exhibits all the characteristics of an autonomous application, including all non-functional requirements related to resiliency. Such a reconciliation service may have the ability to pick up at a point in time it last operated successfully (in case of a failure with the reconciliation service itself) and such an occurrence does not affect or stop the business process itself. Additionally, the events that such a reconciliation service publishes may be consumed by other services for the purposes of monitoring and alerts (in various embodiments, such a reconciliation service is not simply a monitoring and alert function but, rather, an operational function to ensure business resiliency and reconciliation). An effective reconciliation service according to various embodiments may provide sufficient detail in the events it publishes for consuming services to determine the appropriate actions to resolve any issue identified and may provide key insights for telemetry and reliability engineering.

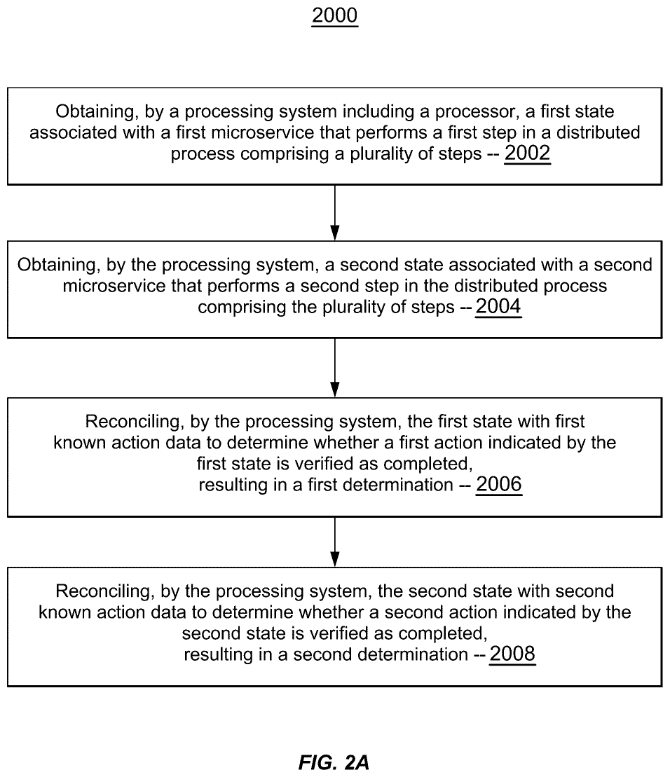

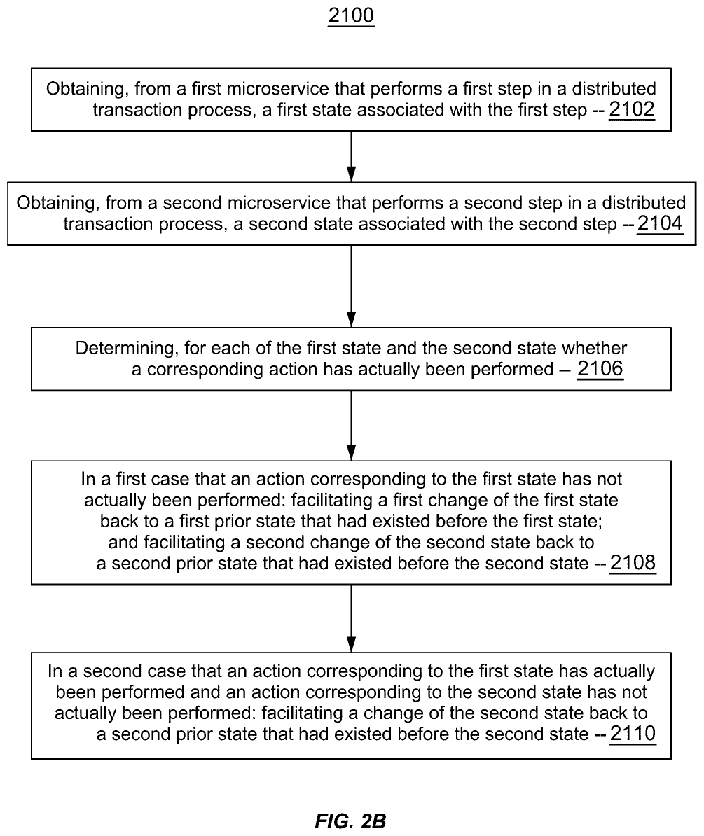

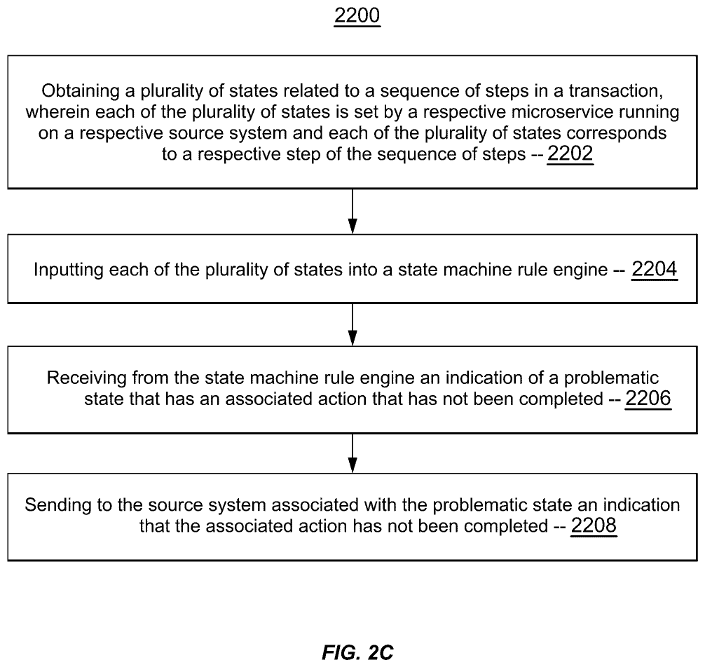

Referring now to FIG. 2A, a method 2000 is illustrated. At step 2002, a processing system including a processor may be configured to obtain a first state associated with a first microservice that performs a first step in a distributed process comprising a plurality of steps, wherein the first step is one of the plurality of steps.

At step 2004, the processing system may be configured to obtain a second state associated with a second microservice that performs a second step in the distributed process comprising the plurality of steps, wherein the second microservice is distinct from the first microservice, and wherein the second step is one of the plurality of steps that follows the first step.

At step 2006, the processing system may be configured to reconcile the first state with first known action data to determine whether a first action indicated by the first state is verified as completed, resulting in a first determination.

At step 2008, the processing system may be configured to reconcile the second state with second known action data to determine whether a second action indicated by the second state is verified as completed, resulting in a second determination.

While for purposes of simplicity of explanation, the respective processes are shown and described as a series of blocks in FIG. 2A, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2B, a method 2100 is illustrated. At step 2102, a first state associated with a first step may be obtained from a first microservice that performs the first step in a distributed transaction process.

At step 2104, a second state associated with a second step may be obtained from a second microservice that performs the second step in the distributed transaction process.

At step 2106, whether a corresponding action has actually been performed may be determined for each of the first state and the second state.

At step 2108, if a first case that an action corresponding to the first state has not actually been performed, facilitating a first change of the first state back to a first prior state that had existed before the first state; and facilitating a second change of the second state back to a second prior state that had existed before the second state.

At step 2110, if a second case that an action corresponding to the first state has actually been performed and an action corresponding to the second state has not actually been performed, facilitating a change of the second state back to a second prior state that had existed before the second state.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2C, a method 2200 is illustrated. At step 2202, a plurality of states related to a sequence of steps in a transaction may be obtained, wherein each of the plurality of states is set by a respective microservice running on a respective source system and each of the plurality of states corresponds to a respective step of the sequence of steps.

At step 2204, each of the plurality of states may be inputted into a state machine rule engine.

At step 2206, an indication of a problematic state that has an associated action that has not been completed may be received from the state machine rule engine.

At step 2208, an indication that the associated action has not been completed may be sent to the source system associated with the problematic state.

While for purposes of simplicity of explanation, the respective processes are shown and described as a series of blocks in FIG. 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Reference will now be made to transaction management using a reconciliation service according to various embodiments. In this regard, in a microservice architecture, business transactions may need to span multiple services to support a given business process. Each service may represent a specific “step” in the business process (see, e.g., tasks 304, 308, 312, 316, and 320 of FIG. 1D). Each service may have its own business logic as well as its own database in which the service state is persisted. This distribution of a business process across a set of autonomous services creates challenges in ensuring data consistency across the services, and in managing failures that may occur with the execution of the transactions that need to span across multiple microservices. Various embodiments address these challenges, such as via incorporation of a reconciliation service into the distributed microservices.

Still referring to transaction management using a reconciliation service, reference will now be made to a certain pattern according to various embodiments. For example, a given long running transaction (see, e.g., tasks 304, 308, 312, 316, and 320 of FIG. 1D) may exemplify an end-to-end business process. This may use a message-driven or service process approach for executing a sequence of local transactions (see, e.g., tasks 304, 308, 312, 316, and 320 of FIG. 1D) where the first transaction in the workflow is initiated by an external request, and each subsequent transaction in the workflow is triggered by the completion of the previous transaction. The local transactions are coordinated via asynchronous messaging and remote calls, or external child workflow may be monitored using the service calls. A reconciliation service (according to various embodiments) may address the challenges of data consistency without having to use a two-phase commit (2pc) protocol (2pc is not recommended as it is blocking, where the object is locked until the transaction completes, and the lock could impact system performance and service availability; additionally, when following 2pc, it is possible to end up in a deadlock, where two transactions mutually lock each other—each transaction requests a lock on a resource the other requires). A reconciliation service (according to various embodiments) not only helps ensure data consistency in a microservice architecture, but is also a pattern for managing failures, through compensating actions. This is a very apt pattern on which to model a reconciliation service which supports an eventual consistency model across bounded contexts in accordance with the CAP theorem.

In various embodiments, the workflow is defined according to a high-level business process where each “step” is executed as a request (command) to a single service with a corresponding update to the state of that service. Conventionally, workflows often cannot be automatically rolled back as each step commits changes to an associated service's database. Therefore, according to various embodiments, compensating transactions are utilized. Each request in the workflow may have a compensating request that may be executed in the event of a failure. These compensating requests undo the transaction in progress by restoring the application's state to its state before the request was made (in another embodiment, compensating requests will ask target/partner systems to take additional steps to make state update). In various embodiments, compensable transactions are those transactions that are followed by steps in the reconciliation service that may fail; not all steps in the workflow need a compensating transaction or reconciliation (e.g., read-only steps).

Reference will now be made to a reconciliation service and the pattern according to various embodiments. The reconciliation service may be an informed observer (in the microservice architecture) that monitors all events (see, e.g., events 302, 306, 310, 314, 318, and 322 of FIG. 1D) and transaction states associated with a given set of steps of a business process. For long-running transactions, e.g., when 2 or more services are being choreographed, the reconciliation service may use the pattern to execute the sequence of steps that must be completed. The reconciliation service (according to an embodiment) also has context for the compensating transactions and events that must be invoked if there is a failure (e.g., if a step in the workflow has not executed; if the steps are not in sequence; and/or if an SLA is breached).

As described herein, various embodiments utilize domain driven design software engineering practices to decompose a business process into a set of interactions that may be implemented in a distributed architecture as microservices. Processing in a distributed, event-based environment provides some significant challenges in terms of ensuring the business process runs and completes successfully and updates the other system(s) correctly. In order to ensure that all necessary transactions that make up the business process fully complete and eventual consistency is maintained across the systems, various embodiments provide a reconciliation capability outside the microservices for the state machine.

As described herein, various embodiments have defined within an architecture (e.g., a banking architecture), a reconciliation service pattern to address the challenges of executing a business process across a set of microservices/systems. A reconciliation service may be a microservice that observes the successes (and failures) of the end-to-end business process across the systems with source or parent workflow last status and updated timestamps. The reconciliation service may be responsible for ensuring all the systems and/or child workflow in-progress and/or terminal statuses necessary are in synchronization and that actions occur successfully for a given business process (e.g., a given business process that is implemented via a set of microservices). The reconciliation service may do this, for example, as an informed observer in the microservice architecture. When any inconsistencies or anomalies are detected, the reconciliation service may provide notification so that corrective, compensating action is taken. The reconciliation service may also act as inspector and make sure each system may resolve the inconsistencies or anomalies automatically with or without manual intervention.

As described herein, some portions of embodiments may be combined with portions of other embodiments.

As described herein, various embodiments provide a reconciliation method for a transaction state machine in a distributed environment (e.g., comprising a plurality of microservices). In one embodiment, financial losses due to inconsistent data related to missed transaction updates and/or inconsistent state information for one or more consumers (or other targets) may be eliminated (or at least reduced). In one embodiment, incorrect reporting due to inconsistent data related to missed transaction updates and/or inconsistent state information for one or more consumers (or other targets) may be eliminated (or at least reduced).

As described herein, various embodiments provide a reconciliation system that keeps track of transactions between source and target systems and reconciles as soon as any out of state transaction/record is found. The reconciliation may be, for example, in real-time or quasi real-time. In one embodiment, based upon transaction type and a state machine rule engine, a reconciliation system may create alert(s) for each target system and also invoke procedure(s) to correct the record.

As described herein, various embodiments provide for real-time (or quasi real-time) reconciliation of transaction steps. The reconciliation may detect one or more discrepancies (e.g., in one or more downstream steps) and then determine whether a transaction should proceed (e.g., after correction) or be cancelled.

As described herein, various embodiments provide for reconciliation in the context of a banking credit, a banking debit, a product fulfillment, or any combination thereof.

As described herein, various embodiments provide for analysis (e.g., artificial intelligence (AI) analysis and/or machine learning (ML) analysis) of missed/failed transactions to predict future missed/failed transactions. In other embodiments, the AI analysis and/or ML analysis may determine whether a particular transaction needs additional reconciliation/verification.

As described herein, various embodiments provide for reconciliation that implements a self-correcting process (e.g., until a transaction is completed and verified).

As described herein, various embodiments provide for reconciliation that will not allow a process to complete until approval to actually compete the transaction is made.

As described herein, various embodiments provide for reconciliation that may be configured and/or managed in real-time (or quasi real-time).

As described herein, various embodiments provide for reconciliation that may instruct a system (e.g., a source system and/or a target system) to make one or more additional attempts to perform a given step.

As described herein, various embodiments provide for a reconciliation service that gives resiliency to the end-to-end business process (rather than only addressing issues with system components as in certain conventional system monitoring).

As described herein, various embodiments provide for a reconciliation service that ensures (or helps to ensure) the successful execution of a business process running in a distributed architecture.

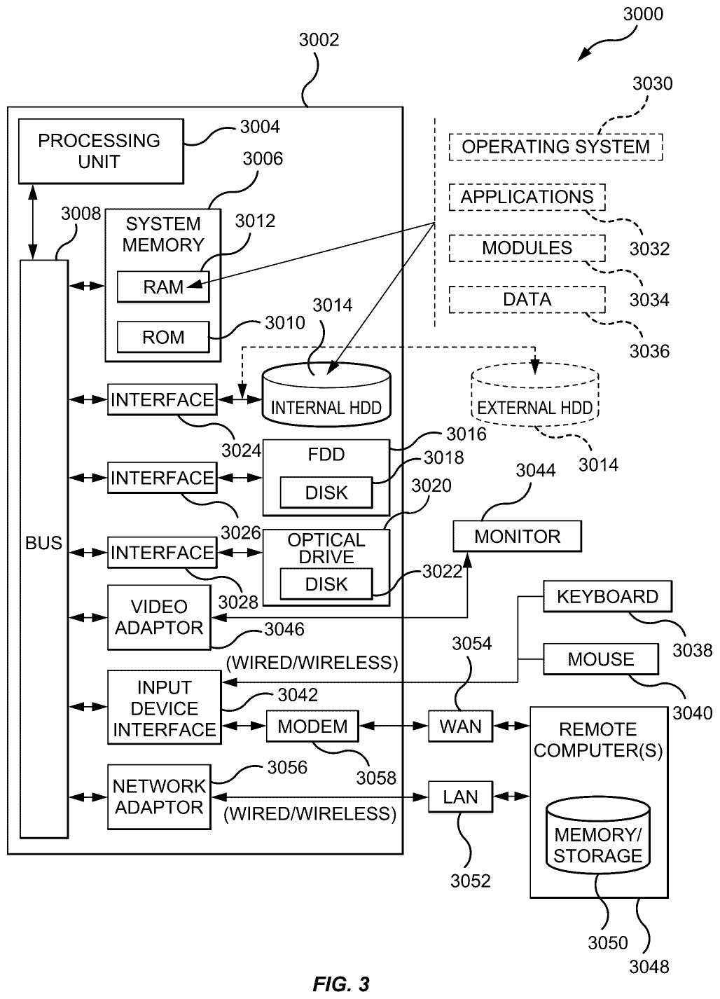

Turning now to FIG. 3, there is illustrated a block diagram of a computing environment in accordance with various aspects described herein. In order to provide additional context for various embodiments of the embodiments described herein, FIG. 3 and the following discussion are intended to provide a brief, general description of a suitable computing environment 3000 in which the various embodiments of the subject disclosure may be implemented. In particular, the computing environment 3000 may be used in computing devices described herein. Each of these devices may be implemented via computer-executable instructions that may run on one or more computers, and/or in combination with other program modules and/or as a combination of hardware and software. For example, computing environment 3000 may facilitate in whole or in part a reconciliation method for a transaction state machine in a distributed environment. Further, each source system, target system, reconciliation system, state machine, or the like may comprise computing environment 3000.

Generally, program modules comprise routines, programs, components, data structures, etc., that perform particular tasks or implement particular abstract data types. Moreover, those skilled in the art will appreciate that the methods may be practiced with other computer system configurations, comprising single-processor or multiprocessor computer systems, minicomputers, mainframe computers, as well as personal computers, hand-held computing devices, microprocessor-based or programmable consumer electronics, and the like, each of which may be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein may be also practiced in distributed computing environments where certain tasks are performed by remote processing devices that are linked through a communications network. In a distributed computing environment, program modules may be located in both local and remote memory storage devices.

Computing devices typically comprise a variety of media, which may comprise computer-readable storage media and/or communications media, which two terms are used herein differently from one another as follows. Computer-readable storage media may be any available storage media that may be accessed by the computer and comprises both volatile and nonvolatile media, removable and non-removable media. By way of example, and not limitation, computer-readable storage media may be implemented in connection with any method or technology for storage of information such as computer-readable instructions, program modules, structured data or unstructured data.

Computer-readable storage media may comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which may be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media may be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 3, the example environment may comprise a computer 3002, the computer 3002 comprising a processing unit 3004, a system memory 3006 and a system bus 3008. The system bus 3008 couples system components including, but not limited to, the system memory 3006 to the processing unit 3004. The processing unit 3004 may be any of various commercially available processors. Dual microprocessors and other multiprocessor architectures may also be employed as the processing unit 3004.

The system bus 3008 may be any of several types of bus structure that may further interconnect to a memory bus (with or without a memory controller), a peripheral bus, and a local bus using any of a variety of commercially available bus architectures. The system memory 3006 comprises ROM 3010 and RAM 3012. A basic input/output system (BIOS) may be stored in a non-volatile memory such as ROM, erasable programmable read only memory (EPROM), EEPROM, which BIOS contains the basic routines that help to transfer information between elements within the computer 3002, such as during startup. The RAM 3012 may also comprise a high-speed RAM such as static RAM for caching data.

The computer 3002 further comprises an internal hard disk drive (HDD) 3014 (e.g., EIDE, SATA), which internal HDD 3014 may also be configured for external use in a suitable chassis (not shown), a magnetic floppy disk drive (FDD) 3016, (e.g., to read from or write to a removable diskette 3018) and an optical disk drive 3020, (e.g., reading a CD-ROM disk 3022 or, to read from or write to other high-capacity optical media such as the DVD). The HDD 3014, magnetic FDD 3016 and optical disk drive 3020 may be connected to the system bus 3008 by a hard disk drive interface 3024, a magnetic disk drive interface 3026 and an optical drive interface 3028, respectively. The hard disk drive interface 3024 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 3002, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, may also be used in the example operating environment, and further, that any such storage media may contain computer-executable instructions for performing the methods described herein.

A number of program modules may be stored in the drives and RAM 3012, comprising an operating system 3030, one or more application programs 3032, other program modules 3034 and program data 3036. All or portions of the operating system, applications, modules, and/or data may also be cached in the RAM 3012. The systems and methods described herein may be implemented utilizing various commercially available operating systems or combinations of operating systems.

A user may enter commands and information into the computer 3002 through one or more wired/wireless input devices, e.g., a keyboard 3038 and a pointing device, such as a mouse 3040. Other input devices (not shown) may comprise a microphone, an infrared (IR) remote control, a joystick, a game pad, a stylus pen, touch screen or the like. These and other input devices are often connected to the processing unit 3004 through an input device interface 3042 that may be coupled to the system bus 3008, but may be connected by other interfaces, such as a parallel port, an IEEE 1394 serial port, a game port, a universal serial bus (USB) port, an IR interface, etc.

A monitor 3044 or other type of display device may be also connected to the system bus 3008 via an interface, such as a video adapter 3046. It will also be appreciated that in alternative embodiments, a monitor 3044 may also be any display device (e.g., another computer having a display, a smart phone, a tablet computer, etc.) for receiving display information associated with computer 3002 via any communication means, including via the Internet and cloud-based networks. In addition to the monitor 3044, a computer typically comprises other peripheral output devices (not shown), such as speakers, printers, etc.

The computer 3002 may operate in a networked environment using logical connections via wired and/or wireless communications to one or more remote computers, such as a remote computer(s) 3048. The remote computer(s) 3048 may be a workstation, a server computer, a router, a personal computer, portable computer, microprocessor-based entertainment appliance, a peer device or other common network node, and typically comprises many or all of the elements described relative to the computer 3002, although, for purposes of brevity, only a remote memory/storage device 3050 is illustrated. The logical connections depicted comprise wired/wireless connectivity to a local area network (LAN) 3052 and/or larger networks, e.g., a wide area network (WAN) 3054. Such LAN and WAN networking environments are commonplace in offices and companies, and facilitate enterprise-wide computer networks, such as intranets, all of which may connect to a global communications network, e.g., the Internet.

When used in a LAN networking environment, the computer 3002 may be connected to the LAN 3052 through a wired and/or wireless communication network interface or adapter 3056. The adapter 3056 may facilitate wired or wireless communication to the LAN 3052, which may also comprise a wireless AP disposed thereon for communicating with the adapter 3056.

When used in a WAN networking environment, the computer 3002 may comprise a modem 3058 or may be connected to a communications server on the WAN 3054 or has other means for establishing communications over the WAN 3054, such as by way of the Internet. The modem 3058, which may be internal or external and a wired or wireless device, may be connected to the system bus 3008 via the input device interface 3042. In a networked environment, program modules depicted relative to the computer 3002 or portions thereof, may be stored in the remote memory/storage device 3050. It will be appreciated that the network connections shown are representative illustrations and other means of establishing a communications link between the computers may be used.

The computer 3002 may be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This may comprise Wireless Fidelity (Wi-Fi) and BLUETOOTH® wireless technologies. Thus, the communication may be a predefined structure as with a conventional network or simply an ad hoc communication between at least two devices.

Wi-Fi may allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network may be used to connect computers to each other, to the Internet, and to wired networks (which may use IEEE 802.3 or Ethernet). Wi-Fi networks operate in the unlicensed 2.4 and 5 GHz radio bands for example or with products that contain both bands (dual band), so the networks may provide real-world performance similar to the basic 10BaseT wired Ethernet networks used in many offices.

In various embodiments, threshold(s) may be utilized as part of determining/identifying one or more actions to be taken or engaged. The threshold(s) may be adaptive based on an occurrence of one or more events or satisfaction of one or more conditions (or, analogously, in an absence of an occurrence of one or more events or in an absence of satisfaction of one or more conditions).

What has been described above includes mere examples of various embodiments. It is, of course, not possible to describe every conceivable combination of components or methodologies for purposes of describing these examples, but one of ordinary skill in the art may recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented may optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than may be recognized by the second item. In a further example of indirect coupling, an action in a first item may cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, may be used in the subject disclosure. For instance, one or more features from one or more embodiments may be combined with one or more features of one or more other embodiments. In one or more embodiments, features that are positively recited may also be negatively recited and excluded from the embodiment with or without replacement by another structural and/or functional feature. The steps or functions described with respect to the embodiments of the subject disclosure may be performed in any order. The steps or functions described with respect to the embodiments of the subject disclosure may be performed alone or in combination with other steps or functions of the subject disclosure, as well as from other embodiments or from other steps that have not been described in the subject disclosure. Further, more than or less than all of the features described with respect to an embodiment may also be utilized.

What is claimed is:

1. A method comprising:
obtaining, by a processing system including a processor, a first state associated with a first microservice that performs a first step in a distributed process comprising a plurality of steps, wherein the first step is one of the plurality of steps;
obtaining, by the processing system, a second state associated with a second microservice that performs a second step in the distributed process comprising the plurality of steps, wherein the second microservice is distinct from the first microservice, and wherein the second step is one of the plurality of steps that follows the first step;
reconciling, by the processing system, the first state with first known action data to determine whether a first action indicated by the first state is verified as completed, resulting in a first determination; and
reconciling, by the processing system, the second state with second known action data to determine whether a second action indicated by the second state is verified as completed, resulting in a second determination.

2. The method of claim 1, further comprising, responsive to the first determination being that the first action indicated by the first state has not been verified as completed:
causing a first rolling back, by the processing system, of the first state to a first prior state that had existed before the first state; and
causing a second rolling back, by the processing system, of the second state to a second prior state that had existed before the second state.

3. The method of claim 2, wherein the causing of the first rolling back comprises:
sending, by the processing system, a first instruction to the first microservice to change the first state to the first prior state that had existed before the first state; and
sending, by the processing system, a second instruction to the second microservice to change the second state to the second prior state that had existed before the second state.

4. The method of claim 1, further comprising, responsive to the second determination being that the second action indicated by the second state has not been verified as completed:
causing a rolling back, by the processing system, of the second state to a second prior state that had existed before the second state.

5. The method of claim 4, wherein the causing of the rolling back comprises:
sending, by the processing system, an instruction to the second microservice to change the second state to the second prior state that had existed before the second state.

6. The method of claim 1, further comprising:
responsive to the first determination being that the first action indicated by the first state has not been verified as completed, sending a first alert; and
responsive to the second determination being that the second action indicated by the second state has not been verified as completed, sending a second alert.

7. The method of claim 1, wherein the plurality of steps form a complete financial transaction.

8. The method of claim 7, wherein the complete financial transaction comprises a purchase of a product, a purchase of a service, a banking transaction, or any combination thereof.

9. The method of claim 8, wherein:
the first action not being verified as completed results from a first failure of a payment being made, a first failure of a funding, a first failure of a settlement, or any first combination thereof; and
the second action not being verified as completed results from a second failure of a payment being made, a second failure of a funding, a second failure of a settlement, or any second combination thereof.

10. The method of claim 1, wherein:
the processing system comprises one or more first servers;
the first microservice operates on one or more second servers, wherein the one or more second servers are distinct from the one or more first servers; and
the second microservice operates on one or more third servers, wherein the one or more third servers are distinct from the one or more first servers and are distinct from the one or more second servers.

11. The method of claim 10, wherein:
the one or more first servers are operated by a first entity;
the one or more second servers are operated by a second entity, wherein the second entity is distinct from the first entity; and
the one or more third servers are operated by a third entity, wherein the third entity is distinct from the first entity and is distinct from the second entity.

12. A non-transitory machine-readable medium comprising executable instructions that, when executed by a processing system including a processor, facilitate performance of operations, the operations comprising:
obtaining, from a first microservice that performs a first step in a distributed transaction process, a first state associated with the first step;
obtaining, from a second microservice that performs a second step in the distributed transaction process, a second state associated with the second step;
determining, for each of the first state and the second state whether a corresponding action has actually been performed;
in a first case that an action corresponding to the first state has not actually been performed:
facilitating a first change of the first state back to a first prior state that had existed before the first state; and
facilitating a second change of the second state back to a second prior state that had existed before the second state; and
in a second case that an action corresponding to the first state has actually been performed and an action corresponding to the second state has not actually been performed:
facilitating a change of the second state back to a second prior state that had existed before the second state.

13. The non-transitory machine-readable medium of claim 12, wherein the distributed transaction process is part of a financial transaction.

14. The non-transitory machine-readable medium of claim 12, wherein:
the action corresponding to the second state not actually having been performed would have been a payment being made, a settlement being made, or any combination thereof.

15. A device comprising:
a processing system including a processor; and
a memory that stores executable instructions that, when executed by the processing system, facilitate performance of operations, the operations comprising:
obtaining a plurality of states related to a sequence of steps in a transaction, wherein each of the plurality of states is set by a respective microservice running on a respective source system and each of the plurality of states corresponds to a respective step of the sequence of steps;
inputting each of the plurality of states into a state machine rule engine;
receiving from the state machine rule engine an indication of a problematic state that has an associated action that has not been completed; and
sending to the source system associated with the problematic state an indication that the associated action has not been completed.

16. The device of claim 15, wherein:
the receiving from the state machine rule engine the indication of the problematic state is responsive to the state machine rule engine obtaining information from a target system on which the associated action was supposed to be performed; and
the information from the target system indicates that the associated action was not performed.

17. The device of claim 16, wherein the sending of the indication to the source system causes the source system to roll back the problematic state to a prior state.

18. The device of claim 17, wherein the operations further comprise:
sending to the target system associated with the problematic state a message indicating that the source system has been sent an indication to roll back the problematic state to a prior state.

19. The device of claim 15, wherein:
the device comprises one or more first servers;
the state machine rule engine is implemented on the one or more first servers;
each source system comprises a respective one or more second servers;
a target system comprises one or more third servers;
the one or more first servers are distinct from the one or more second servers and the one or more third servers; and
the one or more second servers are distinct from the one or more third servers.

20. The device of claim 19, wherein:
the one or more first servers are operated by a first entity;
each of the one or more second servers is operated by a respective distinct second entity;
the one or more third servers are operated by a third entity;
the first entity is distinct from each second entity and the third entity; and
the third entity is distinct from each second entity.
